(19) United States
(12) Patent Application Publication
(10) Pub. No.: US 2019/0047883 A1
(43) Pub. Date: Feb. 14, 2019

(54) Treatment of Dissolved Selenium

(71) Applicant: Evoqua Water Technologies, LLC, Pittsburgh, PA (US)

(72) Inventors: Adam Szczesniak, Berlin, CT (US); Frank L. Sassaman Jr., Fombell, PA (US); Michael W. Wismer, Lino Lakes, MN (US); Samuel A. Mason, Wickliffe, OH (US); Simon P. Dukes, Chelmsford, MA (US)

(21) Appl. No.: 16/077,095

(22) PCT Filed: Feb. 9, 2017
(86) PCT No.: PCT/US2017/017266

§ 371 Date: Aug. 10, 2018

Related U.S. Application Data
(60) Provisional application No. 62/293,504, filed on Feb. 10, 2016.

(51) Int. Cl. C02F 1/52; C02F 1/467

(52) U.S. Cl. CPC C02F 1/5236; C02F 1/66; C02F 1/4678

(57) ABSTRACT

A method of reducing the concentration of dissolved selenium in water includes introducing water having solid selenium-containing particles and a metal that bonds with selenium into a vessel and precipitating a metal-selenium compound from the water. A method of reducing the concentration of dissolved selenium or reducing dissolution of dissolved selenium, including providing a source of electrons into the water to precipitate dissolved selenium compounds is also disclosed. The precipitated compounds are separated from the water to produce decontaminated water. A system for reducing the concentration of dissolved selenium or reducing dissolution of dissolved selenium is also disclosed. The system includes a vessel fluidly connectable to a water source, at least one solid metal source, and a source of electrical voltage electrically connectable to the metal source.

### RELATED APPLICATIONS

This application claims priority under 35 U.S.C. § 119(e) to U.S. Provisional Application Ser. No. 62/293,504 titled “Treatment of Trace Selenium” filed on Feb. 10, 2016, which is herein incorporated by reference in its entirety.

### FIELD OF TECHNOLOGY

Aspects and embodiments disclosed herein relate to systems and methods of reducing a concentration of dissolved selenium in water. More particularly, aspects and embodiments disclosed relate to systems and methods to remove dissolved selenium from water having solid selenium-containing particles by precipitating a metal-selenium compound.

### SUMMARY

In accordance with an aspect, there is provided a method of reducing a concentration of dissolved selenium in water having solid selenium-containing particles comprising introducing the water having solid selenium-containing particles into a vessel, introducing a metal that bonds with selenium into the vessel to form a substantially water-insoluble metal-selenium compound, precipitating the metal-selenium compound from the water, and separating the precipitated metal-selenium compound from the water to produce a decontaminated water having a lower concentration of dissolved selenium than the water.

In some embodiments, the method further comprises providing conditions under which the metal-selenium compound forms from ions of the metal and dissolved selenium ions in the water. Providing the conditions under which the metal-selenium compound precipitates may comprise adjusting at least one of pH, temperature, and concentration of the metal in the water.

According to some embodiments, introducing the metal into the vessel comprises introducing a water-soluble metal salt into the vessel. The water-soluble metal salt may be a salt of the metal that bonds with selenium to form the substantially water-insoluble metal-selenium compound.

According to some embodiments, introducing the metal into the vessel comprises introducing a solid metal source into the vessel. In at least some embodiments, the solid metal source may be introduced by forming the vessel at least partially of the metal or forming a conduit configured to deliver the water to the vessel at least partially of the metal.

The method may further comprise applying a voltage to a solid metal source in the vessel to generate ions of the metal and providing conditions under which the metal-selenium compound may form from the ions of the metal and dissolved selenium ions in the water.

In some embodiments, introducing the metal into the vessel comprises introducing a metal selected from the group consisting of bismuth, cadmium, copper, germanium, iron, manganese, nickel, silver, strontium, thallium, tin, titanium, ytterbium, zinc, zirconium, and mixtures thereof into the vessel.

In accordance with another aspect, there is provided a method of reducing a concentration of dissolved selenium in water having solid selenium-containing particles comprising introducing the water having solid selenium-containing particles into a vessel, providing a source of electrons in electrical communication with the water, and providing conditions under which electrons are transferred from the source of electrons to the solid selenium-containing particles to precipitate dissolved selenium compounds.

According to another aspect, there is provided a method of reducing dissolution of selenium in water having solid selenium-containing particles comprising introducing the water having solid selenium-containing particles into a vessel, providing a source of electrons in electrical communication with the water, and providing conditions under which electrons are transferred from the source of electrons to the solid selenium-containing particles to decrease dissolution of the solid selenium containing particles in the water.

Methods disclosed herein may further comprise separating precipitated selenium compounds from the water to produce a decontaminated water.

In some embodiments, providing a source of electrons in electrical communication with the water comprises introducing zero valent iron media disposed in a cartridge into the vessel.

According to at least some embodiments, providing a source of electrons in electrical communication with the water comprises providing electrical communication between zero valent iron media disposed in a reactor upstream of the vessel and the water in the vessel. For instance, providing electrical communication may comprise contacting the water in the vessel with one or more wires in electrical communication with the reactor containing the zero valent iron media.

In some embodiments, providing a source of electrons in electrical communication with the water comprises providing an electrode in electrical communication with the water.

Methods disclosed herein may further comprise removing at least some of the solid selenium-containing particles from the water. For instance, the at least some of the solid selenium-containing particles may be removed from the water prior to introducing the water into the vessel. Removing at least some of the solid selenium-containing particles may comprise one of magnetic separation, centrifugation, membrane filtration, cartridge filtration, or removing with a hydrocyclone.

In accordance with another aspect, there is provided a system for reducing a concentration of dissolved selenium or reducing dissolution of solid selenium in water comprising a vessel, at least one solid metal source, and a source of electrical voltage. The vessel may be fluidly connectable to a water source having solid selenium-containing particles. The at least one solid metal source may comprise a metal that bonds with selenium and forms a substantially water-insoluble metal-selenium compound. The solid metal source may be positioned within the vessel. The source of electrical voltage may be electrically connectable to the at least one solid metal source.

In some embodiments, the system may further comprise a filter positioned upstream of the vessel. The filter may be configured to remove solid selenium-containing particles from the water source.

In some embodiments, the source of electrical voltage comprises a positively charged electrode and/or a negative electrode.

According to certain embodiments, the metal may be selected from the group consisting of bismuth, cadmium, copper, germanium, iron, manganese, nickel, silver, strontium, thallium, tin, titanium, ytterbium, zinc, zirconium, and mixtures thereof.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a graph of selenium concentration in zero valent iron system reactors and downstream vessels in a selenium wastewater treatment system;

FIG. 2 is a flowchart of a method for reducing a concentration of dissolved selenium in water having solid selenium-containing particles, in accordance with one aspect;

FIG. 3 is a flowchart of an alternate method for reducing a concentration of dissolved selenium or reducing dissolution of selenium in water having solid selenium-containing particles, in accordance with one aspect; and

FIG. 4 is a schematic drawing of a system for reducing a concentration of dissolved selenium or reducing dissolution of solid selenium in water, in accordance with one aspect.

### DETAILED DESCRIPTION

Wastewater generated from processes used in coal-fired electric power plants, petroleum refineries, and those related to mining operations may be contaminated with selenium and other metals and metalloids. Selenium can be toxic at elevated levels and some selenium species may be carcinogenic. Selenium exists in various forms in nature and treatment of selenium contaminated water and wastewater is complicated.

Selenium treatment and removal systems may employ methods to chemically reduce soluble selenium to its metallic form, Se (0), and its reduced form, Se (-II), selenide. For example, two industrially available technologies for the removal of selenium from water are biological treatments and zero-valent iron (ZVI) treatments. ZVI treatment can remove selenium in different oxidation states through redox reactions, adsorption, and co-precipitation in a reactor. In ZVI and iron co-precipitation treatment systems, soluble forms of selenium may be combined with ferrous and ferric ions present in the treatment solution to create insoluble species. Similarly, while not necessarily required, metals may be present in certain biological treatment systems that combine with soluble selenium ions.

Generally, water that has been treated by such a method or system has a very low concentration of dissolved selenium. Formation and dissolution of iron-selenium compounds or other metal-selenium compounds in chemical reducing conditions are in equilibrium, favoring formation of insoluble metal-selenium compounds. In some instances, the formed insoluble metal-selenium compounds escape the reactor with the treated water that is being removed for downstream processing or use. These formed insoluble metal-selenium compounds may end up in downstream reactors or vessels. For example, ZVI media having adsorbed selenium may end up in a clarifier downstream from a ZVI reactor.

Under oxidizing conditions, for example, exposure to the atmosphere which may occur in a clarifier or to a ferric iron reaction byproduct (Fe⁺³) which may occur downstream from a ZVI or metal co-precipitation reaction, the insoluble-soluble selenium equilibrium shifts from favoring the insoluble metal-selenium compounds to favoring re-dissolution of small concentrations of selenium. Dissolved selenium may appear as selenite (SeO₃²⁻) or selenate (SeO₄²⁻) in the treated water if the oxidizing conditions are strong enough. Residual seleinde (Se²⁻) may be present in the water from when the water was in a reducing environment because, for example, ferrous selenide is sparingly soluble in water. Re-dissolution of selenium is undesirable because it increases the concentration of selenium in the previously treated water.

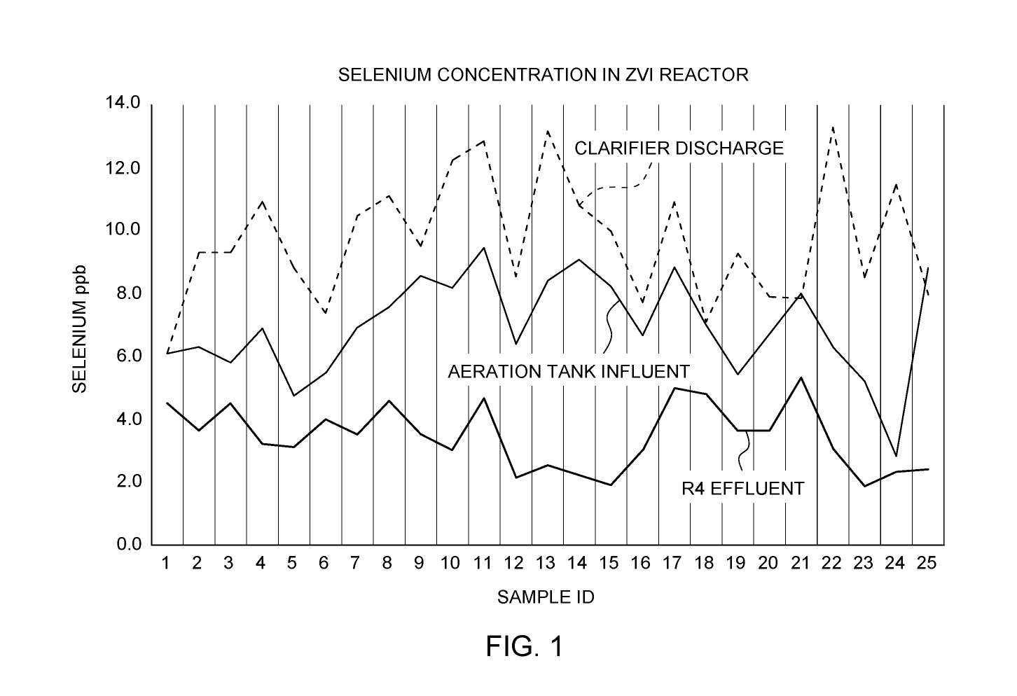

In an exemplary ZVI system, it was noted that selenium was at a low concentration while wastewater remained in the iron-containing reactors. After the wastewater left the reactors as effluent, selenium began to re-enter solution. FIG. 1 is a graph of selenium concentration in different ZVI system chambers. Treated water exits the ZVI reactors from an outlet (shown in FIG. 1 as R4) and enters the aeration tank, the first tank in the clarifier operational unit. Water exits the treatment system at the clarifier discharge, which is the last point in the clarifier unit. As seen in FIG. 1, the concentration of selenium in the water at the R4 outlet point is lower than the concentration of selenium at the aeration tank influent and clarifier discharge, respectively. Accordingly, selenium seems to re-dissolve increasingly between these points. Ideally, the selenium concentration would remain as low as in the R4 outlet effluent.

Selenium precipitation technology is capable of producing treated water having a selenium concentration at least as low as 2.0 parts per billion (ppb), as shown in FIG. 1. However, due to the above summarized reactions, the concentration of dissolved selenium may slowly increase in later processing stages of the treated water. The lack of a viable method to overcome or reduce the concentration of re-dissolved selenium into treated water has thwarted attempts to develop selenium precipitation technology into a reliable selenium removal solution when discharge requirements for selenium concentration are very low.

Systems and methods for reducing a concentration of dissolved selenium in water having solid selenium-containing particles are disclosed herein. In particular, systems and methods disclosed herein may be employed in water that has been exposed to an oxidizing agent, whereby at least some of the solid selenium has dissolved into the water, increasing the concentration of dissolved selenium in the water.

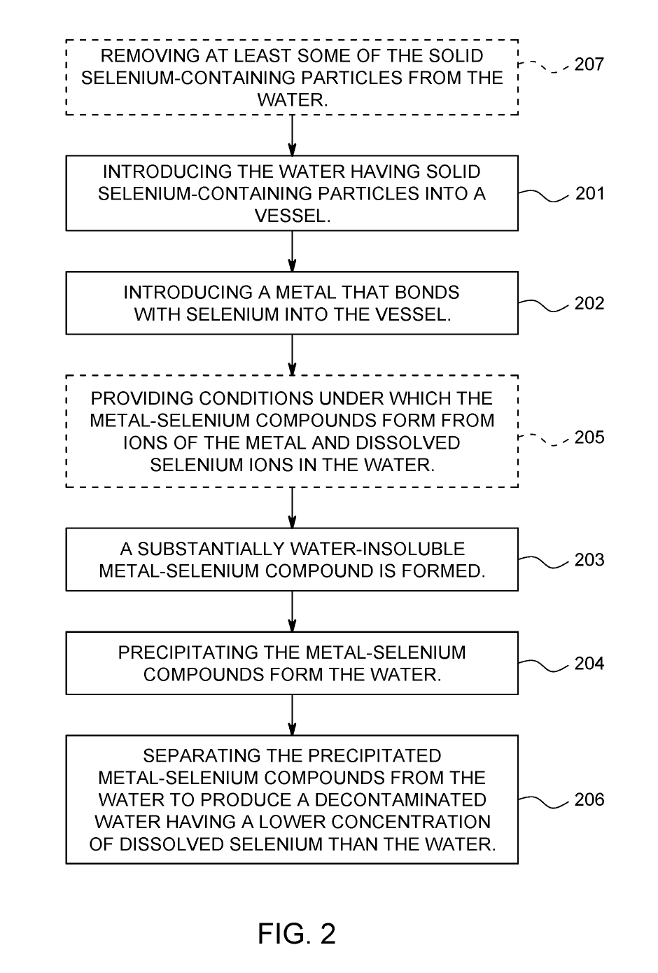

In accordance with an aspect, there is provided a method of reducing a concentration of dissolved selenium in water having solid selenium-containing particles. A flowchart of an exemplary method is shown in FIG. 2. The method according to this exemplary flowchart may comprise introducing the water having solid selenium-containing particles into a vessel (act 201), introducing a metal that bonds with selenium into the vessel (act 202) to form a substantially water-insoluble metal-selenium compound (act 203), precipitating the metal-selenium compound from the water (act 204), and separating the precipitated metal-selenium compound from the water (act 206) to produce a decontaminated water having a lower concentration of dissolved selenium than the contaminated water. In some embodiments, the method may further comprise providing conditions under which the metal-selenium compound forms from ions of the metal and dissolved selenium ions in the water (act 205). In some embodiments, the method may further comprise removing at least some of the solid selenium-containing particles from the water (act 207) prior to introducing the water into the vessel.

According to certain embodiments, the water having solid selenium-containing particles comprises product from a selenium removal system. The solid-selenium containing particles may comprise iron-selenium particles or other metal-selenium particles that were formed in a reactor configured to remove selenium from water. For instance, the particles may have been formed in a reactor, such as a ZVI reactor, or a biological reactor. The water having solid selenium-containing particles, if exposed to an oxidizing agent, for example, the atmosphere, may experience an increase in a concentration of dissolved selenium. Systems and methods disclosed herein are provided to reduce such a concentration of dissolved selenium in the water. In some embodiments, the water having solid selenium-containing particles comprises between about 2.5 ppb and about 10.0 ppb dissolved selenium. The water having solid selenium-containing particles may have between about 2.5 ppb and about 8.0 ppb selenium, or more than about 4.0 ppb selenium.

In some embodiments, the method comprises introducing the water or metal into a clarifier, aeration tank, or thickener configured to receive water having solid selenium-containing particles. In some embodiments, introducing the water or metal into the vessel comprises introducing the water or metal into a reactor, tank, or conduit. Contents within the clarifier, aeration tank, or thickener may be exposed to the atmosphere or another oxidizing agent. The reactor, tank, or conduit may be enclosed and exposed to an oxidizing agent. Introducing the water and metal into a vessel further comprises creating physical contact between the water and the metal.

According to certain embodiments, the metal bonds with selenium to form a substantially water-insoluble metal-selenium compound. Metal-selenium compounds have varying degrees of solubility. As disclosed herein, metal-selenium compounds are compounds that comprise a metal (Mₓ) and selenium (Se_{y}). The metal-selenium compound (MₓSe_{y}) may be formed from a reaction between the metal and an oxidized selenium species, for example metal-selenide (Mₓ+Se²⁻), metal-selenite, (Mₓ+SeO₃²⁻), and metal-selenate (Mₓ+SeO₄²⁻) species.

Table 1 shows the solubility characteristics of several metal selenides, selenites and selenates. The specific concentration of each dissolved selenium species in the water may be dependent on the degree of reduction/oxidation agent in the immediate environment. The solubility characteristics will be dependent on the metal and the available oxidized selenium species, as outlined in Table 1.

TABLE 1
solubility of metal-selenium compounds

| | Metal-Se | | | |
|---|---|---|---|---|
| Metal | formula | Selenide | Selenite | Selenate |
| Aluminum | Al₂Se₃ | Decomposes | | |
| Antimony | Sb₂Se₃ | Very soluble | | |
| Barium | BaSe | Decomposes | | Soluble |
| Bismuth | Bi₂Se₃ | Insoluble | | |
| Cadmium | CdSe | Insoluble | | Very soluble |
| Calcium | CaSe | | | Very soluble |
| Cobalt | CoSe | | | Soluble |
| Copper | CuSe | Insoluble | Insoluble | Very soluble |
| Gallium | GaSe | Decomposes | | |
| Germanium | GeSe₂ | Insoluble | | |
| Iron, Fe(II) | FeSe | Slightly soluble | | |
| Lead | PbSe | Insoluble | | Insoluble |
| Lithium | Li₂Se | Decomposes | | |
| Magnesium | MgSe | Decomposes | | Very soluble |
| Manganese | MnSe | Insoluble | Very soluble | Soluble |
| Mercury | HgSe | Insoluble | | |
| Nickel | NiSe | Insoluble | | Soluble |
| Potassium | K₂Se | Soluble | Soluble | Very soluble |
| Silver | Ag₂Se | Insoluble | | Slightly soluble |
| Sodium | Na₂Se | Decomposes | Soluble | Very soluble |
| Strontium | SrSe | Decomposes | | Insoluble |
| Thallium | Tl₂Se | Insoluble | | Soluble |
| Tin | SnSe | Insoluble | | |
| Titanium | TiSe₂ | Insoluble | Insoluble | |
| Ytterbium | | | Insoluble | Slightly soluble |
| Zinc | ZnSe | Insoluble | | Soluble |
| Zirconium | ZrSe₂ | | Insoluble | Soluble |

The metal-selenium compounds indicated to be insoluble in Table 1 may precipitate, while the soluble or decomposing metal-selenium compounds may not precipitate in water. In some embodiments, the substantially water-insoluble metal-selenium compound may be an insoluble compound listed in Table 1. However, the water-insoluble metal-selenium compound is not limited to the compounds listed in Table 1. Any substantially water-insoluble metal-selenium compound may precipitate and be separated from the water.

Insoluble metal-selenium compounds include insoluble metal-selenide compounds, insoluble metal-selenite compounds, and insoluble metal-selenate compounds. Many of the metal-selenide species shown in Table 1 are insoluble. Copper, titanium, ytterbium, and zirconium form the insoluble metal-selenite species of Table 1. Additionally, while most of the metal-selenate species in Table 1 are soluble, lead and strontium selenate appear to be insoluble.

Table 1 includes mostly metal-selenate and metal-selenide solubility information. Selenates are the most oxidized form of selenium in the environment, and are generally reduced to metallic selenium, selenite or selenides during treatment. In many cases, selenium may not be present in selenate form after a selenium treatment process, due to selenate's general propensity for reduction during treatment. Selenite, the second most oxidized form of selenium, may be easily oxidized to selenate. Thus, in some embodiments, selenium may not be long lasting in selenite form.

Systems and methods disclosed herein produce a metal-selenium compound by combining a metal with dissolved selenium. In certain embodiments, the metal may be a metal that forms a substantially-water insoluble metal-selenium compound. The metals are not limited to the metals and compounds listed in Table 1. In some embodiments the metal may be selected from the group consisting of bismuth, cadmium, copper, germanium, iron, lead, manganese, mercury, nickel, silver, strontium, thallium, tin, titanium, ytterbium, zinc, zirconium, and mixtures thereof.

According to some embodiments, introducing a metal into the vessel comprises introducing a water-soluble metal salt into the vessel. The water-soluble metal salt may be a salt of the metal that bonds with selenium to form a substantially water-insoluble metal-selenium compound. For instance, in some embodiments, the water-soluble metal salt may be a salt of a metal selected from the group consisting of bismuth, cadmium, copper, germanium, iron, lead, manganese, mercury, nickel, silver, strontium, thallium, tin, titanium, ytterbium, zinc, zirconium, and mixtures thereof. In accordance with certain embodiments, soluble salts may include, but are not limited to, chloride salts and sulfate salts.

Introducing the water-soluble metal salt into the vessel, and thus into the water, may produce dissolved metal ions that react with dissolved selenium in the water. The dissolved metal ions and dissolved selenium may form a water-insoluble metal-selenium compound, according to certain embodiments as previously described herein. In some embodiments, the method comprises providing conditions under which a metal-selenium compound is formed from ions of the metal and dissolved selenium in the water, precipitating from the water to produce a solid metal-selenium compound.

According to some embodiments, introducing a metal into the vessel comprises introducing a solid metal source into the vessel. The at least one solid metal source may comprise a metal that bonds with selenium and forms a substantially water-insoluble metal-selenium compound, as previously discussed herein. For instance, introducing a metal into the vessel may comprise introducing a solid form of a metal selected from the group consisting of bismuth, cadmium, copper, germanium, iron, lead, manganese, mercury, nickel, silver, strontium, thallium, tin, titanium, ytterbium, zinc, zirconium, and mixtures thereof into the vessel. Introducing the solid metal source may comprise positioning the solid metal source within the vessel, such that it is in contact with the water having solid selenium-containing particles or dissolved selenium. In some embodiments, the method comprises introducing one or more solid metal units. In some embodiments, the method comprises providing conditions under which the solid metal source may dissolve, releasing metal ions and/or electrons into the vessel.

In at least some embodiments, the solid metal source may be introduced by forming the vessel at least partially of the metal or forming a conduit configured to deliver the water to the vessel at least partially of the metal. For instance, the method may comprise lining the vessel or a conduit fluidly connected to the vessel with the metal. In some embodiments, the method may comprise placing a liner or internally exposed surface containing the metal within the vessel or a conduit fluidly connected to the vessel, such that the metal is in contact with the water.

Systems and methods disclosed herein are configured to or include precipitating the metal-selenium compound from the water. In some embodiments, by introducing a metal that bonds with selenium into the vessel, an insoluble metal-selenium compound is formed and readily precipitates. The concentration of insoluble metal-selenium compounds may be dependent on the concentration of metal introduced into the vessel, the concentration of dissolved selenium in the water, or the solubility limit of the metal-selenium compound. In each instance, precipitating the metal-selenium compound may comprise completely precipitating the metal selenium compound, such that little to no soluble metal-selenium compound or dissolved selenium remains in the water.

In some embodiments, the method further comprises providing conditions under which the metal-selenium compound forms from ions of the metal and dissolved selenium ions in the water. For instance, providing the conditions under which the metal-selenium compound forms may comprise adjusting at least one of pH, temperature, and concentration of the metal in the water. The specific conditions under which the compound will readily form may be dependent on the metal introduced into the vessel and the degree of reduction/oxidation in the immediate environment.

The method may further comprise providing conditions under which the formed metal-selenium compound precipitates from solution. The specific conditions under which the formed compound may precipitate, may be dependent on at least one of pH, temperature, and concentration of compounds in the water. Accordingly, providing conditions under which the formed metal-selenium compound precipitates may include adjusting at least one of pH, temperature, and concentration of ions.

In some embodiments, the method comprises adjusting pH to be between about 5.0 and about 11.0, between about 6.0 and about 9.0, or between about 7.0 and about 7.5.

The method of reducing a concentration of dissolved selenium in water may further comprise applying a voltage to a solid metal source in the vessel to generate ions of the metal. While not wishing to be bound by a particular theory, generally when an external voltage source is applied to the solid metal source, the metal dissolves to form ions in the water. The solid metal source may release metal cations. As it dissolves, the solid metal source may also release electrons that may flow through an electrical connection, for instance electrical wires, to a terminal or electrode having negatively charged electrons on its surface. In some embodiments, the solid metal source may supply metal cations for reaction with selenium species and/or may supply electrons which reduce selenium.

In some embodiments, the ions of the metal will react with dissolved selenium or dissolved selenium ions to form water-insoluble metal compounds. For instance, the method may comprise providing a source of electrical voltage and contacting the source of electrical voltage with the solid metal source in the vessel. The source of electrical voltage may be contacted with the solid metal source by providing an electrode or wire electrically connected to the solid metal source. The source of electrical voltage may be connected to the solid metal source through a wire or positively charged electrode and to a second, negatively charged, electrode such that electrons released as the solid metal source dissolves may flow through the circuit (for e.g. through the wires or other connection) to the second electrode.

In some embodiments, the method may comprise providing conditions under which the metal-selenium compound may precipitate from ions of the metal and dissolved selenium ions in the water.

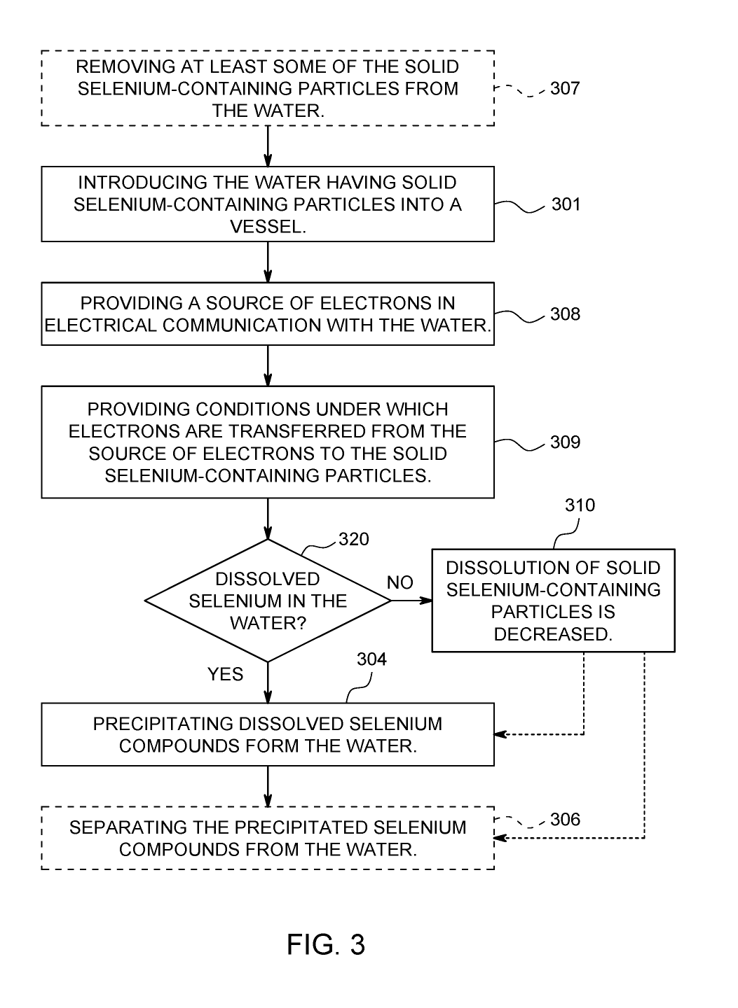

In accordance with another aspect, there is provided another method of reducing a concentration of dissolved selenium in water having solid selenium-containing particles. A flowchart of an exemplary method is shown in FIG. 3. The method according to this exemplary flowchart may comprise introducing the water having solid selenium-containing particles into a vessel (act 301), providing a source of electrons in electrical communication with the water (act 308), and providing conditions under which electrons are transferred from the source of electrons to the solid selenium-containing particles (act 309) to precipitate dissolved selenium compounds (act 304). In some embodiments, the method may further comprise separating precipitated selenium compounds from the water (act 306). In some embodiments, the method may further comprise removing at least some of the solid selenium-containing particles from the water (act 307) prior to introducing the water into the vessel.

According to at least some embodiments, providing a source of electrons in electrical communication with the water comprises providing electrical communication between the water in the vessel and ZVI media disposed within the vessel or in one or more reactors upstream of the vessel. While not wishing to be bound by a particular theory, it is believed that during the chemical process of oxidizing, the zero valent iron acts as an electron generator to chemically reduce dissolved selenium cations and oxyanions to insoluble forms, for example solid selenium-containing particles. During the selenium reduction reaction, dissolved selenium forms are adsorbed to the surface of the iron and are chemically incorporated into iron oxidation byproducts. Generally, iron metal can be used to reduce selenium ions to their solid states which precipitate on the iron or to an insoluble selenium-iron complex. However, as previously discussed, the insoluble selenium-iron complex may be oxidized to re-dissolve selenium into the water in downstream reactors. By providing ZVI generated electrons to downstream reactors, the dissolved selenium may be reduced or re-precipitated to insoluble selenium-iron complex.

In some embodiments, the ZVI media is provided in the form of particles which may include, for example, nanoparticles and/or microparticles. The ZVI media may additionally or alternatively be provided in the form of steel wool. In some embodiments, providing a source of electrons in electrical communication with the water comprises introducing ZVI media disposed in a cartridge into the vessel. For instance, the ZVI media may be disposed in at least one of a cartridge, a fluidized bed reactor, a packed bed reactor, or a mixed bed reactor. In some embodiments, the ZVI media and/or the reactor or reactors containing the ZVI media are provided substantially or wholly free of microorganisms or bacterial populations capable of metabolically reducing ions of, for example, selenium, mercury, arsenic or other metals, or nitrates.

Providing electrical communication between ZVI media disposed in a reactor upstream of the vessel and the water in the vessel may comprise contacting the water in the vessel with one or more wires in electrical communication with the reactor containing the zero valent iron media. In some embodiments, providing electrical communication between ZVI media upstream of the vessel and the water in the vessel may comprise providing one or more steel or metal containing conduits configured to deliver water from the upstream ZVI reactor to the vessel, such that the electrons may be transferred through the steel or metal containing conduits. The electrons generated by the ZVI media in the reactor may reduce or re-precipitate dissolved selenium or selenium ions.

According to certain embodiments, providing a source of electrons in electrical communication with the water comprises providing an electrode in electrical communication with the water. In some embodiments, the electrode may be connected to an exterior source of electricity. For instance, the electrode may be connected to a battery, a circuit, or other electrical source. The electrode may provide electrons to the water to reduce selenium compounds, as discussed above with reference to the zero valent iron media.

The method may further comprise providing conditions under which electrons are transferred from the source of electrons to the solid selenium-containing particles. For example, the method may comprise facilitating a transfer of electrons from zero valent iron media or an electrode to the water having solid selenium-containing particles. The electrons may be transferred from the source of electrons to the solid selenium-containing particles through water or one or more wires. In some embodiments, providing conditions under which electrons are transferred from the source of electrons to the solid selenium-containing particles comprises one or more of adjusting a pH or temperature of the water or adjusting a voltage, power, or intensity of the source of electrons or the exterior source of electricity.

In some embodiments, there is little to no dissolved selenium in the water. Accordingly, little to no dissolved selenium may precipitate. Instead, or in addition to, precipitating dissolved selenium compounds from the water (act 304), the method may comprise decreasing dissolution of solid selenium-containing particles (act 310). This differentiation is exemplified by decision act 320, as shown in FIG. 3.

According to another aspect, also shown as an exemplary method in the flowchart of FIG. 3, there is provided a method of reducing dissolution of selenium in water having solid selenium-containing particles comprising introducing the water having solid selenium-containing particles into a vessel (act 301), providing a source of electrons in electrical communication with the water (act 308), and providing conditions under which electrons are transferred from the source of electrons to the solid selenium-containing particles (act 309) to decrease dissolution of the solid selenium containing particles in the water (act 310). In some embodiments, the method may further comprise separating precipitated selenium compounds from the water (act 306).

As previously discussed herein, solid selenium-containing particles in water, for instance, in water downstream from a selenium removal system, may be exposed to detrimental oxidation which may re-dissolve selenium into the water. The re-dissolved selenium increases the selenium concentration in the water. The methods previously disclosed herein may be employed to reduce dissolution of selenium in the water. For example, by providing a ZVI generated electrons or electrons generated by an electrode or other source of electrons to water having dissolved selenium, the equilibrium reaction between dissolved selenium and solid selenium-containing particles may favor the solid selenium, decreasing or inhibiting the dissolution of selenium into the water.

Systems and methods disclosed herein may employ the use of a magnetic separation chamber, a centrifuge, a membrane filter, a cartridge filter, or a hydrocyclone configured to remove solid selenium-containing particles from the water. For instance, at least some of the solid selenium-containing particles may be removed from the water prior to introducing the water into the vessel. In some embodiments, at least some of the precipitated metal-selenium compounds may be separated from the water.

Membrane and cartridge filters may be used to remove at least some solid selenium-containing particles from the water. The membrane and cartridge filters comprise a porous film with a specific pore size rating. The membrane and cartridge filters may be configured to separate solid selenium-containing particles by physical mechanical separation. In some embodiments, a membrane filter comprises a microporous filter, a nanoporous filter, an ultraporous filter, a screen, or a sieve. In certain embodiments, a cartridge filter may be a flowmatic filter that comprises a porous film having a 1-50 micron rating, activated carbon, or both.

The centrifuge may be an industrial centrifuge configured to sediment suspended solids. Centrifuges may apply centripetal acceleration to separate denser substances from less dense substances. For instance, a centrifuge may be fluidly connected to the vessel and configured to spin down solid selenium-containing particles, producing a supernatant water having a lower concentration of solid selenium-containing particles. The water having a lower concentration of solid selenium-containing particles may be essentially free of solid selenium-containing particles.

Magnetic separation may be used to separate solid selenium-containing particles from the water. In some embodiments, magnetically susceptible solid selenium-containing particles are attracted to magnets in a magnetic separation chamber. The attracted particles may be separated from the water. Some magnetically susceptible solid selenium-containing particles may include iron, nickel, cobalt, and bismuth particles.

A hydrocyclone may be used to separate particles in a liquid suspension. Hydrocyclones use centripetal force and fluid resistance to separate liquid streams by density or size. For instance, the ratio of centripetal force to fluid resistance may be high for dense or coarse streams and low for light or fine streams. The dense or coarse streams may be separated from the light or fine streams, whereby one stream exits a first end of the hydrocyclone and an opposite stream exits a second end of the hydrocyclone. Generally, hydrocyclones do not have moving parts. The separation may be driven by the geometry of the hydrocyclone and the characteristics of the feed stream. Accordingly, a hydrocyclone may be used in a continuous reaction to separate a stream comprising solid selenium-containing particles from water.

Methods disclosed herein may further comprise separating precipitated selenium compounds from the water to produce a decontaminated water. According to certain embodiments, a metal-selenium compound or the precipitated compound may be separated from the water with a magnetic separation chamber, a centrifuge, a membrane filter, a cartridge filter, or a hydrocyclone, as previously described herein. The magnetic separation chamber, centrifuge, membrane filter, cartridge filter, or hydrocyclone may be fluidly connected downstream from the vessel. In some embodiments, the metal-selenium compound or the precipitated compound may be separated in a clarifier, aeration tank, thickener, or settling tank by sedimentation. The decontaminated water may comprise between about 2.0 and about 6.0 ppb selenium. In some embodiments, the decontaminated water comprises less than about 4.0 ppb selenium. In some embodiments, the decontaminated water comprises between about 0.5 ppb selenium and about 2.0 ppb selenium. For example, the decontaminated water may comprise between about 0.5 ppb selenium and 1.5 ppb selenium.

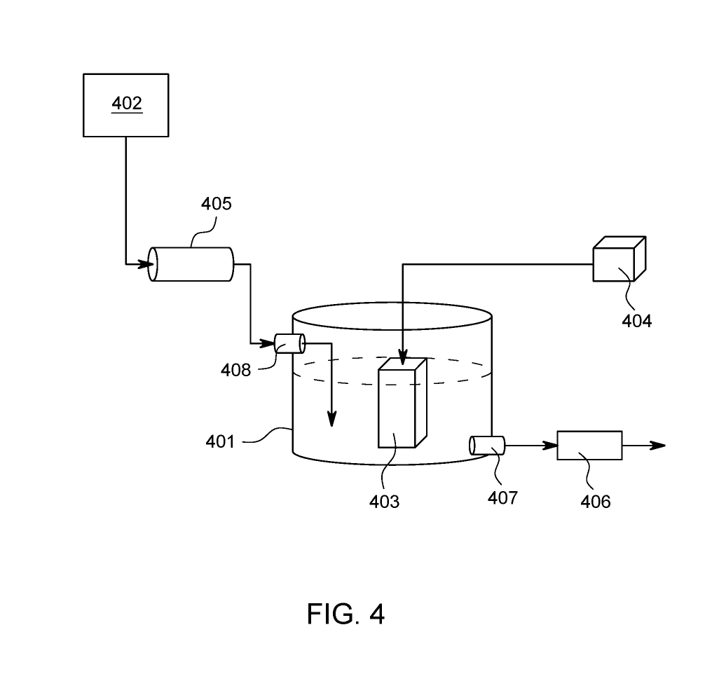

In accordance with another aspect, there is provided a system for reducing a concentration of dissolved selenium or reducing dissolution of solid selenium in water. A schematic drawing of an exemplary system is shown in FIG. 4. The system may comprise a vessel 401, at least one solid metal source 403, and a source of electrical voltage 404. In some embodiments, the system may comprise a water source 402 fluidly connectable to the vessel, an inlet 408 of the vessel 401, a filter 405 positioned upstream of the vessel 401, and a filter 406 positioned downstream of the vessel 401. In some embodiments, the vessel 401 may comprise an outlet 407 configured to discharge water and/or the metal-selenium compound from the vessel 401. In some embodiments, reference numerals 405 and/or 406 elements may additionally or alternatively represent a centrifuge, a hydrocyclone, or a magnetic separation chamber. In some embodiments, the system may comprise one or more wires, a positively charged electrode (not shown), and/or a negative electrode (not shown).

The vessel may be fluidly connectable to a water source having solid selenium-containing particles. For example, the water source may be fluidly connectable to an inlet of the vessel. In some embodiments, the water source may be a metal co-precipitation reactor or a biological reactor. For instance, the water source may be a ZVI reactor. The solid selenium-containing particles may include iron-selenium particles or other metal-selenium particles that were formed in an upstream reactor configured to remove selenium from water.

In some embodiments, the vessel comprises a reactor, tank, or conduit positioned downstream from a water source. The vessel may comprise a clarifier or aeration tank positioned downstream from a water source and configured to further process treated water. The vessel may be exposed to the atmosphere or enclosed.

The at least one solid metal source may comprise a metal that bonds with selenium and forms a substantially water-insoluble metal-selenium compound, as previously discussed herein. The solid metal source may be positioned within the vessel. In some embodiments, the solid metal source may comprise one or more solid metal units. The one or more solid metal units may each be electrically connected to a source of electrical voltage, one or more positive or negative electrodes, electrically connected to each other, or a combination.

In some embodiments, the system or the solid metal source may comprise one or more vessels or conduits formed at least partially of the metal. For instance, the vessel, or a conduit fluidly connected to the vessel, may be lined or comprise an exposed surface containing the metal. The lining or exposed surface may be in fluid contact with the water. The lining or exposed surface may further be in electrical contact with a source of electrical voltage. Thus, in some embodiments, the vessel or a conduit are supplied with a positive voltage and configured to deliver electrons to a negative electrode and positive ions of the metal to the water having solid selenium-containing particles, as a result of the flow of electrons.

The source of electrical voltage may be electrically connectable to the at least one solid metal source. In some embodiments, the source of electrical voltage may be a positively charged electrode in contact with the solid metal source. In certain embodiments, a battery, an electric generator, a natural energy source, or any other source of electrical voltage connectable to the at least one solid metal source may be connected by one or more wires.

In some embodiments, the system may further comprise a filter positioned upstream of the vessel. The filter may be configured to remove solid selenium-containing particles from the water source. The filter may be, for example a membrane filter or a cartridge filter, as previously described herein. In some embodiments, the system comprises a filter positioned downstream of the vessel configured to separate the metal-selenium compound from water.

According to certain embodiments, the vessel may be fluidly connected to a centrifuge, a hydrocyclone, or a magnetic separation chamber, as previously described herein. The centrifuge, hydrocyclone, or magnetic separation chamber may be configured to remove solid selenium-containing particles or separate the metal-selenium compound from the water. Each of the centrifuge, hydrocyclone, or magnetic separation chamber may be positioned upstream or downstream of the vessel.

### Example: Copper Salt

Pilot tests were run using a Pironox® zero valent iron system (Evoqua Water Technologies, Warrendale, Pa.) treating a sample of stripped sour water (SWS) at a petroleum refinery for removal of selenium. Selenium in SWS is initially present as selenocyanate.

In the Pironox® pilot, four 1500 gallon continuously stirred tank reactors (R1, R2, R3, and R4) were arranged in series. Influent entered the series through R1 and cascaded by gravity through R2-R4, subsequently. During the process, selenocyanate was transformed to metallic selenium, Se (0), and selenide, Se (-II). Effluent from R4 was sampled. Three sets of tests were run on consecutive days using samples collected each day.

Effluent samples per test consisted of two control samples (C1 and C2) and four experimental samples (S3, S4, S5 and S6). Copper sulfate, CuSO₄.5H₂O, was added to effluent samples S3-S6 in varying concentrations, to determine whether the metal would enhance removal of selenium.

Each of the samples was treated as follows: settled solids in the samples were remixed to suspend them. The samples were aerated for 25 minutes to oxidize residual ferrous iron from the Pironox® treatment. Sodium hydroxide solution was added to the samples to achieve a pH of 7.0-7.5. The pH level facilitated precipitation of oxidized iron as ferric hydroxide, Fe(OH)₃. Anionic or cationic polymer was added and mixed for 2 minutes to flocculate the precipitated solids. After mixing, the solids were allowed to settle for 30 minutes. The samples were filtered through 0.45 micron syringe disk filters, preserved with nitric acid and submitted for selenium analysis.

Table 2 summarizes the quantified residual selenium and copper in the treated samples.

TABLE 2
Selenium and copper concentration in test samples

| | | Test 1 | | Test 2 | | Test 3 | |
|---|---|---|---|---|---|---|---|
| | | Residual | | Residual | | Residual | |
| | Added | Metals | | Metals | | Metals | |
| Sample | Cu, | Se, | Cu, | Se, | Cu, | Se, | Cu, |
| ID | ppb | ppb | ppb | ppb | ppb | ppb | ppb |
| C1 | 0 | 7.9 | — | 8.0 | — | 3.4 | — |
| C2 | 0 | 2.7 | — | 5.0 | — | 5.7 | — |
| 3 | 1,000 | 0.432 | 380 | 0.628 | 190 | 0.420 | 600 |
| 4 | 5,000 | 0.324 | 890 | 0.050 | 500 | 0.660 | 790 |
| 5 | 500 | — | — | 1.540 | 55 | 0.128 | 150 |
| 6 | 500 | — | — | 3.1 | 56 | 0.188 | 170 |

For residual selenium, the method detection limit (MDL) was 2.1 ppb and the detection limit (DL) was estimated at 0.05 ppb. The underlined values in Table 2 identify quantified selenium concentrations between the MDL and the DL. Generally, the DL (also called the Instrument Detection Limit or IDL) is defined as the concentration of the contaminant that is greater than 3 standard deviations above a baseline noise value detected during the contaminant measurement. By definition, values below the DL are instrument noise. The MDL is statistically determined by testing samples of the contaminant near the expected DL value. The MDL is a better measure of the actual ability of the method to provide an accurate result. However, the MDL incorporates random and systematic errors, as well as the baseline noise value, so it will generally be higher than the DL.

In each test, selenium concentration in the experimental samples is below the concentration in the control samples, suggesting that addition of low concentrations of copper ions effectively reduces dissolved selenium. Even lower copper concentrations than those tested are expected to provide similar results, until the minimum effective threshold level is reached.

Accordingly, aerating or oxidizing a water having solid-selenium containing particles may dissolve selenium from the solid particles into the water. Introducing a metal that bonds with selenium in a vessel containing the water may precipitate the dissolved selenium. The precipitated selenium may then be separated from the water, producing a decontaminated water.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of’ and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed. For example, those skilled in the art may recognize that the method, and components thereof, according to the present disclosure may further comprise a network or systems or be a component of a system for reducing a concentration of dissolved selenium in water. It is therefore to be understood that the embodiments described herein are presented by way of example only and that, within the scope of the appended claims and equivalents thereto; the disclosed embodiments may be practiced otherwise than as specifically described. The present systems and methods are directed to each individual feature, system, or method described herein. In addition, any combination of two or more such features, systems, or methods, if such features, systems, or methods are not mutually inconsistent, is included within the scope of the present disclosure. The steps of the methods disclosed herein may be performed in the order illustrated or in alternate orders and the methods may include additional or alternative acts or may be performed with one or more of the illustrated acts omitted.

Further, it is to be appreciated that various alterations, modifications, and improvements will readily occur to those skilled in the art. Such alterations, modifications, and improvements are intended to be part of this disclosure, and are intended to be within the spirit and scope of the disclosure. In other instances, an existing facility may be modified to utilize or incorporate any one or more aspects of the methods and systems described herein. Thus, in some instances, the systems may involve removing dissolved selenium from water. Accordingly the foregoing description and figures are by way of example only. Further the depictions in the figures do not limit the disclosures to the particularly illustrated representations.

While exemplary embodiments are disclosed herein, many modifications, additions, and deletions may be made therein without departing from the spirit and scope of the inventive aspects and their equivalents, as set forth in the following claims.

What is claimed is:

1. A method of reducing a concentration of dissolved selenium in water having solid selenium-containing particles, the method comprising:
introducing the water having solid selenium-containing particles into a vessel;
introducing a metal that bonds with selenium into the vessel to form a substantially water-insoluble metal-selenium compound;
precipitating the metal-selenium compound from the water; and
separating the precipitated metal-selenium compound from the water to produce a decontaminated water having a lower concentration of dissolved selenium than the water.

2. The method of claim 1, further comprising providing conditions under which the metal-selenium compound forms from ions of the metal and dissolved selenium ions in the water.

3. The method of claim 2, wherein providing the conditions under which the metal-selenium compound precipitates comprises adjusting at least one of pH, temperature, and concentration of the metal in the water.

4. The method of claim 1, further comprising removing at least some of the solid selenium-containing particles from the water prior to introducing the water into the vessel.

5. The method of claim 4, wherein removing at least some of the solid selenium-containing particles comprises removing at least some of the solid selenium-containing particles by one of magnetic separation, centrifugation, membrane filtration, cartridge filtration, or with a hydrocyclone.

6. The method of claim 1, wherein introducing the metal into the vessel comprises introducing a water-soluble metal salt into the vessel.

7. The method of claim 1, wherein introducing the metal into the vessel comprises introducing a solid metal source into the vessel.

8. The method of claim 7, wherein introducing a solid metal source into the vessel comprises one of forming the vessel at least partially of the metal and forming a conduit configured to deliver the water to the vessel at least partially of the metal.

9. The method of claim 7, further comprising:
applying a voltage to the solid metal source to generate ions of the metal; and
providing conditions under which the metal-selenium compound forms from the ions of the metal and dissolved selenium ions in the water.

10. The method of claim 1, wherein introducing the metal into the vessel comprises introducing a metal selected from the group consisting of bismuth, cadmium, copper, germanium, iron, manganese, nickel, silver, strontium, thallium, tin, titanium, ytterbium, zinc, zirconium, and mixtures thereof into the vessel.

11. A method of reducing a concentration of dissolved selenium or reducing dissolution of selenium in water having solid selenium-containing particles, the method comprising:
introducing the water having solid selenium-containing particles into a vessel;
providing a source of electrons in electrical communication with the water; and
providing conditions under which electrons are transferred from the source of electrons to the solid selenium-containing particles to precipitate dissolved selenium compounds or to decrease dissolution of the solid selenium-containing particles in the water.

12. The method of claim 11, further comprising separating the precipitated selenium compounds from the water to produce a decontaminated water.

13. The method of claim 11, further comprising removing at least some of the solid selenium-containing particles from the water prior to introducing the water into the vessel.

14. The method of claim 13, wherein removing at least some of the solid selenium-containing particles comprises removing the solid selenium-containing particles by one of magnetic separation, centrifugation, membrane filtration, cartridge filtration, or with a hydrocyclone.

15. The method of claim 11, wherein providing the source of electrons comprises introducing zero valent iron media disposed in a cartridge into the vessel.

16. The method of claim 11, wherein providing the source of electrons comprises providing electrical communication between zero valent iron media disposed in a reactor upstream of the vessel and the water in the vessel.

17. The method of claim 16, wherein providing the electrical communication comprises contacting the water in the vessel with one or more wires in electrical communication with the reactor containing the zero valent iron media.

18. The method of claim 11, wherein providing the source of electrons comprises providing an electrode in electrical communication with the water.

19. A system for reducing a concentration of dissolved selenium or reducing dissolution of solid selenium in water, the system comprising:
a vessel fluidly connectable to a water source having solid selenium-containing particles;
at least one solid metal source comprising a metal that bonds with selenium and forms substantially water-insoluble metal-selenium compounds within the vessel; and
a source of electrical voltage electrically connectable to the at least one solid metal source.

20. The system of claim 19, further comprising a filter positioned upstream of the vessel and configured to remove solid selenium-containing particles from the water source.

21. The system of claim 19, wherein the metal is selected from the group consisting of bismuth, cadmium, copper, germanium, iron, manganese, nickel, silver, strontium, thallium, tin, titanium, ytterbium, zinc, zirconium, and mixtures thereof.

22. The system of claim 19, wherein the source of electrical voltage comprises a positively charged electrode and/or a negative electrode.
